(19) United States
(12) Patent Application Publication
(10) Pub. No.: US 2009/0115686 A1
(43) Pub. Date: May 7, 2009

(54) DISPLAY SYSTEM, DISPLAY APPARATUS AND CONTROL METHOD THEREOF

(75) Inventor: Kye-won RYOU, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/179,112

(22) Filed: Jul. 24, 2008

(30) Foreign Application Priority Data
Nov. 5, 2007 (KR) 10-2007-0112361

(51) Int. Cl. G09G 5/00; G09G 1/28

(52) U.S. Cl. 345/2.1; 345/22

(57) ABSTRACT

A display system includes a server supplying an image signal through a network communication and at least one display apparatus displaying the image signal received through the network communication. The at least one display apparatus includes a display unit displaying the image signal thereon, a sensor device sensing a color coordinate of the image signal displayed on the display unit and a communication unit communicating with the server. The server adjusts the image signal with a reference color coordinate and supplies the adjusted image signal to an originating display apparatus from among the at least one display apparatus which supplied the color coordinate to the server.

### CROSS-REFERENCE TO RELATED APPLICATION

This application claims priority from Korean Patent Application No. 10-2007-0112361, filed on Nov. 5, 2007, in the Korean Intellectual Property Office, the disclosure of which is incorporated herein by reference in its entirety.

### BACKGROUND OF THE INVENTION

1. Field of the Invention

Apparatuses and methods consistent with the present invention relate to a display system, a display apparatus and a control method thereof, and more particularly, to a display system which supplies an image signal to a plurality of display apparatuses connected to a server, a display apparatus and a control method thereof

2. Description of the Related Art

Generally, a display apparatus such as a liquid crystal display (LCD) and a plasma display panel (PDP) is employed in a TV or a computer monitor to display an image thereon.

Recently, several display apparatuses are installed in public places such as an exhibition hall or an airport to display various kinds of information. As shown in FIG. 1, a plurality of display apparatuses 1, 2, . . . N is connected with a server 10 supplying an image signal, through a network. That is, the plurality of display apparatuses 1, 2, . . . N is connected with the server 10 through a LAN. Each of the display apparatuses 1, 2, . . . N may receive identical or different image signals from the server 10 to display the image signals thereon.

The plurality of display apparatuses 1, 2, . . . N may vary in a module processing an image signal, or performance, property and lifespan of a display panel displaying an image. Thus, a color deviation occurs in images displayed on the display panel.

For example, it is assumed that the plurality of display apparatuses 1, 2, . . . and N is equivalent in performance. If an error occurs in a display panel of the first display apparatus 1, the display panel is replaced with a new display panel. Then, the color deviation occurs between an image displayed on the first display apparatus 1 and an image displayed on the remaining display apparatuses 2, . . . N.

If the color deviation occurs in the conventional display apparatuses, a user should adjust the color of the display apparatus himself/herself However, it is not easy to adjust the color to remove the color deviation between the display apparatuses. Also, it is inconvenient to reinstall the display apparatuses after the color is adjusted.

### SUMMARY OF THE INVENTION

Accordingly, it is an aspect of the present invention to provide a display system which reduces a color deviation between images displayed on a plurality of display apparatuses connected to a server, a display apparatus and a control method thereof.

Also, it is another aspect of the present invention to provide a display system which senses a color coordinate of an image displayed on a display apparatus through a sensor and receives an adjusted image signal from a server with the sensed color coordinate not to cause a color deviation between displayed images, a display apparatus and a control method thereof.

Additional aspects of the present invention will be set forth in part in the description which follows and, in part, will be obvious from the description, or may be learned by practice of the present invention.

The foregoing and/or other aspects of the present invention are also achieved by providing a display system comprising a server which supplies an image signal through a network and a plurality of display apparatuses which display the image signal received through the network, wherein at least one display apparatus of the plurality of display apparatus comprising a display unit which displays the image signal thereon, a sensor device which senses a color coordinate of the image signal displayed on the display unit, and a communication unit which communicates with the server, and wherein the server receives the sensed color coordinate from the at least one display apparatus, adjusts the image signal with a reference color coordinate, and supplies the adjusted image signal to the at least one display apparatus supplying the sensed color coordinate.

The sensor devices may be installed in the at least two of the plurality of display apparatuses.

The communication unit may communicate with the server through a wired local area network(LAN) or a wireless LAN.

The at least one display apparatus may further comprise a storage unit storing inherent information therein, and the server may receive the color coordinate and the information from the at least one display apparatus.

The information may comprise an internet protocol (IP) address, and the server may supply the adjusted image signal to the received IP address.

The color coordinate sensed by the sensor device may be generated by sensing the image signal displayed on a front surface of the display unit.

The reference color coordinate may be stored in the server by a user.

The server may adjust the image signal when a deviation between the received color coordinate and the reference color coordinate is outside of a range,

The reference color coordinate may comprise a color coordinate supplied from one of the plurality of display apparatuses selected by the server.

The server may adjust the image signal transmitted to another of the plurality of display apparatuses among the at least one display apparatus with the reference color coordinate when a deviation between the reference color coordinate, and the color coordinate supplied by the another of the plurality of display apparatuses is outside of a range, and supplies the adjusted image signal to the another of the plurality of display apparatuses.

The foregoing and/or other aspects of the present invention are also achieved by providing a display apparatus which displays an image signal supplied from a server through via a network, the display apparatus comprising: a display unit which displays the image signal thereon; a sensor device which senses a color coordinate of the image signal displayed on the display unit; and a communication unit which communicates with the server through the network, wherein the communication unit transmits the color coordinate to the server and receives an adjusted image signal corresponding to the transmitted color coordinate.

The display apparatus may further comprise a storage unit which stores information therein, wherein the communication unit supplies the color coordinate and the information to the server.

The inherent information may comprise an internet protocol(IP) address, and the communication unit may supply the color coordinate and the IP address to the server.

The sensor device may be provided in a front surface of the display unit and sense the image signal displayed on the display unit to generate the color coordinate sensed by the sensor device.

The communication unit may communicate with the server through a wired local area network(LAN) or a wireless LAN.

The foregoing and/or other aspects of the present invention are also achieved by providing a control method of a display apparatus which displays an image signal supplied by a server through a network, the control method comprising: displaying the image signal; sensing a color coordinate of the displayed image signal; transmitting the color coordinate to the server; and receiving an adjusted image signal corresponding to the transmitted color coordinate.

The control method may further comprise storing information, wherein the transmitting the color coordinate to the server comprises supplying the color coordinate together with the information to the server.

The information may comprise an internet protocol(IP) address, and the transmitting the color coordinate to the server comprises supplying the color coordinate and the IP address to the server.

### BRIEF DESCRIPTION OF THE DRAWINGS

The above and/or other aspects of the present invention will become apparent and more readily appreciated from the following description of exemplary embodiments, taken in conjunction with the accompanying drawings of which:

FIG. 1 illustrates a conventional display system;

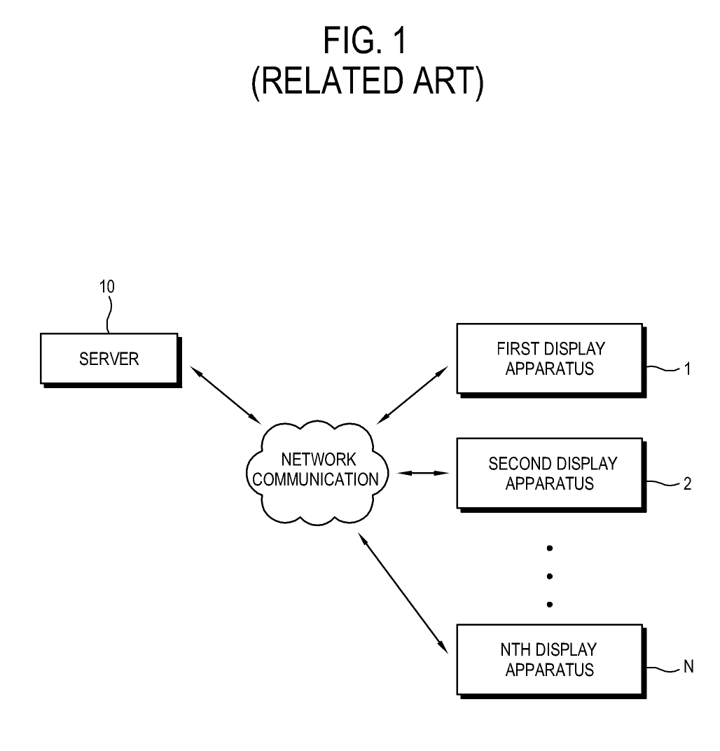

FIG. 2 is a block diagram of a display system according to an exemplary embodiment of the present invention;

FIG. 3 is a flowchart to describe a control method of a first display apparatus of the display system according to an exemplary embodiment of the present invention; and

FIG. 4 is a flowchart to describe a control method of a server of the display system according to an exemplary embodiment of the present invention.

### DETAILED DESCRIPTION OF EXEMPLARY EMBODIMENTS

Hereinafter, exemplary embodiments of the present invention will be described with reference to accompanying drawings, wherein like numerals refer to like elements and repetitive descriptions will be avoided as necessary.

### First Exemplary Embodiment

Hereinafter, a display system according to a first exemplary embodiment of the present invention will be described in detail.

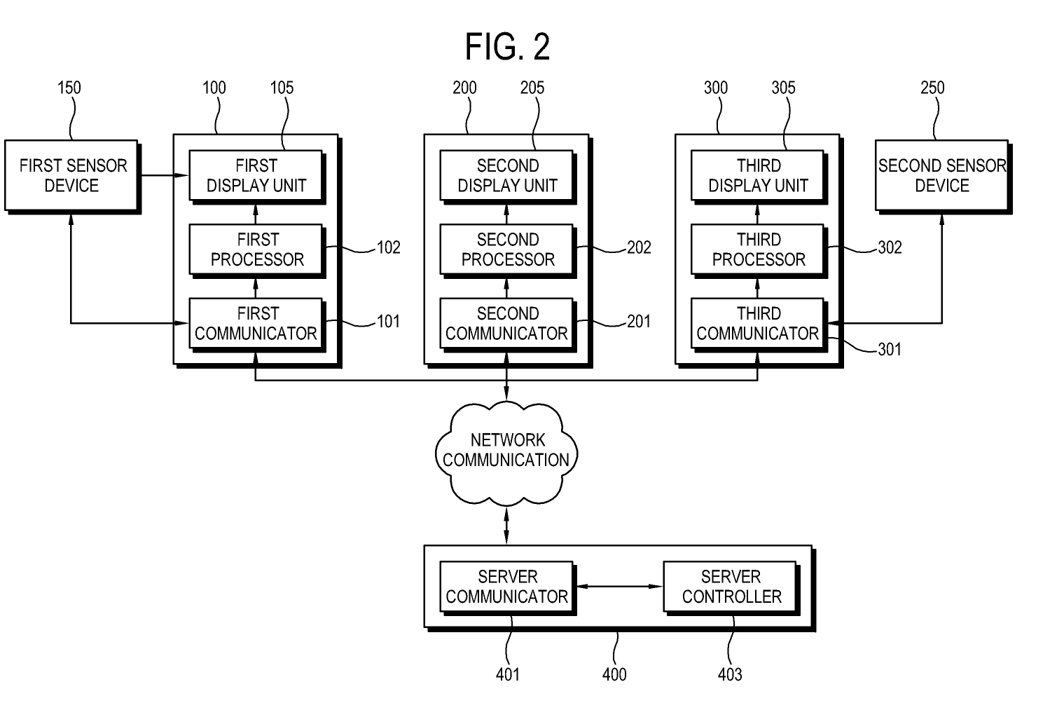

FIG. 2 is a block diagram of the display system according to the first exemplary embodiment of the present invention. The display system includes at least two display apparatuses, a first sensor device 150 and a server 400. The display system according to an exemplary embodiment of the present invention includes a first display apparatus 100, a second display apparatus 200 and a third display apparatus 300.

The first, second and third display apparatuses 100, 200 and 300 include first, second and third communicators 101, 201 and 301; first, second and third processors 102, 202 and 302; and first, second and third display units 105, 205 and 305, respectively. Hereinafter, description of the elements of the first display apparatus 100 will also relate to similar elements of the second and third display apparatuses 200 and 300.

The first communicator 101 communicates with the server 400 (to be described later) and receives an image signal from the server 400. The first communicator 101 may include a wired LAN, a wireless LAN or a modem to be connected to the server 400.

The first communicator 101 communicates with the server 400 according to a corresponding protocol (e.g. TCP/IP protocol). Here, the first communicator 101 uses inherent information of the first display apparatus 100. The inherent information may include an IP address of the first display apparatus 100. The inherent information may be stored in a storage unit (not shown) integrally provided in the first communicator 101 or the first processor 102.

The first communicator 101 may further include a connection port (e.g. USB port, a serial port, etc.) to be connected with a first sensor device 150 (to be described later). The first communicator 101 receives a color coordinate from the connected first sensor device 150.

The first communicator 101 supplies the color coordinate received from the first sensor device 150 to the server 400 together with the inherent information stored in the storage unit.

The first processor 102 processes the image signal received through the first communicator 101. The image signal is converted into a format, e.g. a digital RGB signal to be displayed on the first display unit 105, and is outputted to the first display unit 105.

The first processor 102 may have various functions corresponding to formats of the inputted image signal. For example, the first processor 102 may have an A/D conversion function converting various types of image signals into digital image signals, a digital decoding function, a scaling function scaling a vertical frequency, resolution and picture ratio of a digital image signal and/or an analog image signal according to an output standard of the first display unit 105 and a predetermined format conversion function.

The first display unit 105 displays the image processed by the first processor 102. For example, the first display unit 105 includes an LCD module. Alternatively, the first display unit 105 may include various types of display modules such as a digital light processing (DLP) and a PDP.

The first sensor device 150 according to an exemplary embodiment of the present invention is connected with the display apparatus. The first sensor device 150 senses an image displayed on the connected display apparatus and generates a color coordinate.

The first sensor device 150 may be connected with at least one display apparatus and detached therefrom automatically or manually. The first sensor device 150 may be provided in an external part of the display unit or in an internal part of the display apparatus as long as it senses the displayed image.

The display system includes at least one sensor device. According to an exemplary embodiment of the present embodiment, the display system includes a first sensor device 150 and a second sensor device 250. The first sensor device 150 is connected to the first display apparatus 100 while the second sensor device 250 is connected to the third display apparatus 300. Each of the display apparatuses 100, 200 and 300 may be connected to the sensor devices 150 and 250.

The first sensor device 150 senses an image displayed on the first display unit 105 and generates a color coordinate. The color coordinate represents values of a color. The color coordinate may be represented by coordinate values (x, y) through RGB (red, green and blue), CMY (cyan, magenta and yellow) and HSI (hue, saturation and intensity).

The first sensor device 150 senses an image periodically and generates a color coordinate. The first sensor device 150 supplies the generated color coordinate to the first display apparatus 100 through the first communicator 101. The first display apparatus 100 transmits the color coordinate inputted by the first communicator 101 to the server 400.

The second sensor device 250 senses an image displayed on the third display unit 305 of the third display apparatus 300 periodically and generates a color coordinate. The second sensor device 250 supplies the color coordinate to the third display apparatus 300 through the third communicator 301. The third display apparatus 300 transmits the color coordinate inputted by the third communicator 301 to the server 400.

The server 400 according to an exemplary embodiment of the present embodiment may have various types of image signals which are playable. For example, the image signals may include moving picture signals. The server 400 supplies the image signal to the connected display apparatuses 100, 200 and 300. The server 400 may include a server communicator 401 and a server controller 403.

The server communicator 401 communicates with the first, second and third display apparatuses 100, 200 and 300 which are connected to the server 400. The server communicator 401 transmits the image signal to the IP address, i.e., inherent information of the first, second and third display apparatuses 100, 200 and 300. The server communicator 401 receives the IP address and a sensing value from one of the first, second and third display apparatuses 100, 200 and 300 to transmit to the server controller 403.

The server controller 403 controls the server communicator 401 to transmit the image signal to the IP address of the first, second and third display apparatuses 100, 200 and 300 that are connected to the server 400. Here, the server controller 403 may convert the image signal into a format, e.g. a packet according to a protocol.

The server controller 403 periodically receives the color coordinate from at least one of the first, second and third display apparatuses 100, 200 and 300 through the server communicator 401. The server controller 403 compares the inputted color coordinate with a preset reference color coordinate. The server controller 403 adjusts the image signal with the reference color coordinate. The preset reference color coordinate may be set by a user's input.

The server controller 403 controls the server communicator 401 to transmit the adjusted image signal to the IP address received together with the color coordinate. Thus, the deviation between the color coordinates of the first, second and third display apparatuses 100, 200 and 300 may be reduced.

For example, if a first color coordinate is received from the first display apparatus 100 which is connected with the first sensor device 150, the server controller 403 adjusts the image signal to convert the received first color coordinate into the reference color coordinate, and supplies the adjusted image signal to the first display apparatus 100. If a second color coordinate is received from the third display apparatus 300 which is connected with the second sensor device 250, the server controller 403 adjusts the image signal to convert the second color coordinate into the reference color coordinate, and supplies the adjusted image signal to the second display apparatus 200.

Particularly, the server controller 403 according to the present invention may supply test image signals having the same pattern to the first, second and third display apparatuses 100, 200 and 300. In this case, the server controller 403 compares the color coordinate inputted to the server 400 after the test image signals are supplied, with the reference color coordinate to adjust the image signal.

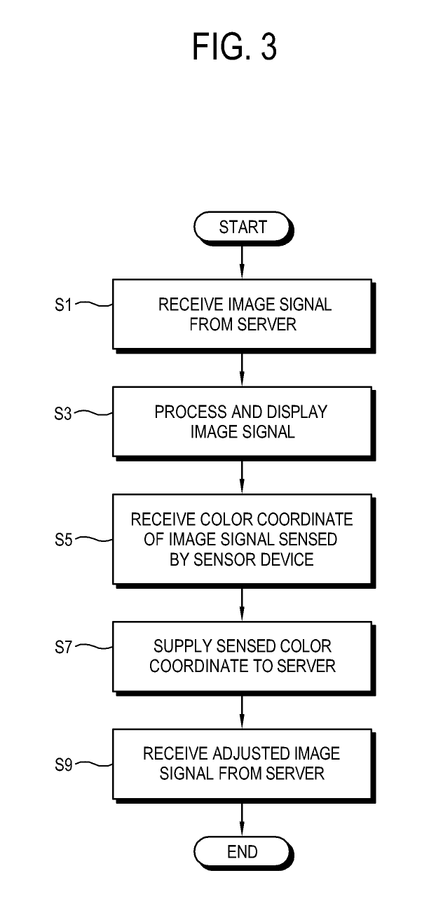

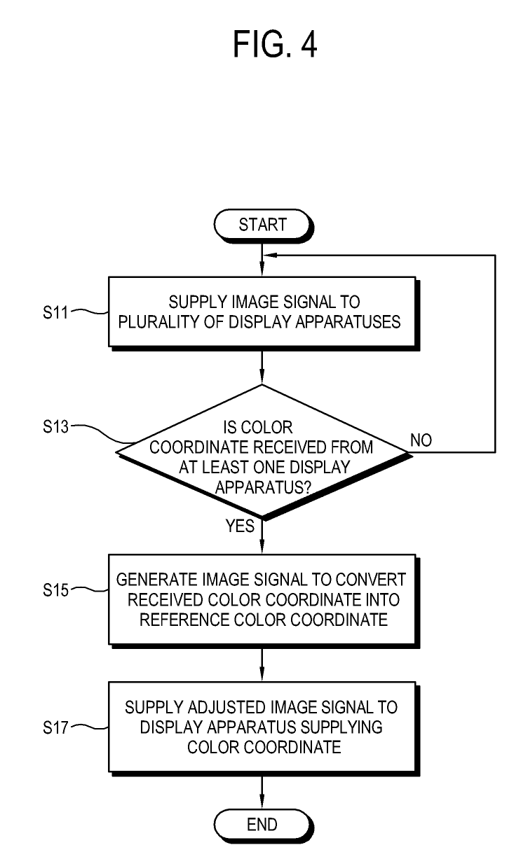

A control method of the display system according to an exemplary embodiment of the present invention will be described with reference to FIGS. 3 and 4. FIG. 3 is a flowchart describing a control process of the first display apparatus 100 according to an exemplary embodiment of the present invention. FIG. 4 is a flowchart describing a control process of the server 400 according to an exemplary embodiment of the present invention.

As shown in FIG. 3, the first display apparatus 100 receives the image signal from the server 400 through the network (S1). The first display apparatus 100 processes and displays the received image signal (S3).

The first sensor device 150 senses the image displayed on the first display unit 105 and supplies the color coordinate to the first display apparatus 100 (S5). The first display apparatus 100 transmits the color coordinate to the server 400 together with the IP address, i.e. the inherent information (S7).

The first display apparatus 100 receives the adjusted image signal from the server 400 (S9), and processes the adjusted image signal to display it.

As shown in FIG. 4, the server 400 transmits the image signal to the IP address of the plurality of display apparatuses 100, 200 and 300 through the network (S11).

The server 400 determines whether the color coordinate is transmitted from at least one display apparatus (S13).

If the color coordinate is received from at least one display apparatus at operation S13, the server controller 403 adjusts the image signal to convert the received color coordinate into the reference color coordinate (S15).

The server controller 403 transmits the adjusted image signal to the IP address received together with the color coordinate (S17).

The server 400 transmits the adjusted image signal to the display device whose color coordinate is not the reference color coordinate, by using the color coordinate of the image signals displayed on the plurality of display apparatuses connected thereto. Thus, color deviation does not occur in the images displayed on the respective display apparatuses.

### Second Exemplary Embodiment

Hereinafter, a display system according to a second exemplary embodiment of the present invention will be described with reference to FIG. 2. Repetitive elements of the display system according to the second exemplary embodiment will be not described unnecessarily.

A server controller 403 sets a color coordinate inputted from at least one display apparatus, as a reference color coordinate. The server controller 403 determines a deviation between the set reference color coordinate and a color coordinate inputted from another display apparatus.

If the deviation between the reference color coordinate and the color coordinate inputted from the another display apparatus is outside of an allowable range, the server controller 403 adjusts the image signal to convert the color coordinate into the reference color coordinate.

For example, it is assumed that a first display apparatus 100 transmits a first color coordinate and a third display apparatus 300 transmits a second color coordinate. The server controller 403 sets the first color coordinate as the reference color coordinate.

The server 400 determines the deviation between the first color coordinate set as the reference color coordinate, and the second color coordinate. The server 400 determines whether the deviation between the first and second color coordinates is outside of the preset allowable range. If the deviation is outside of the allowable range, the server 400 adjusts the image signal to convert the second color coordinate into the first color coordinate. The adjusted image signal is transmitted to the third display apparatus 300.

Thus, even if the plurality of display apparatuses is connected to the server 400, color deviation between the plurality of display apparatuses may be prevented.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A display system comprising:
a server which supplies an image signal through a network; and
a plurality of display apparatuses which display the image signal received through the network,
wherein at least one display apparatus of the plurality of display apparatuses comprises a display unit which displays the image signal thereon, a sensor device which senses a color coordinate of the image signal displayed on the display unit, and a communication unit which communicates with the server, and
wherein the server receives the sensed color coordinate from the at least one display apparatus, adjusts the image signal with a reference color coordinate, and supplies the adjusted image signal to the at least one display apparatus supplying the sensed color coordinate.

2. The display system according to claim 1, wherein sensor devices are installed in at least two of the plurality of display apparatuses.

3. The display system according to claim 2, wherein the communication unit communicates with the server through a wired local area network (LAN) or a wireless LAN.

4. The display system according to claim 1, wherein the one display apparatus further comprises a storage unit storing information therein, and
the server receives the color coordinate and the information from the one display apparatus.

5. The display system according to claim 4, wherein the information comprises an internet protocol (IP) address, and
the server supplies the adjusted image signal to the received IP address.

6. The display system according to claim 1, wherein the color coordinate sensed by the sensor device is generated by sensing the image signal displayed on a front surface of the display unit.

7. The display system according to claim 1, wherein the reference color coordinate is stored in the server by a user.

8. The display system according to claim 7, wherein the server adjusts the image signal when a deviation between the received color coordinate and the reference color coordinate is outside of a range.

9. The display system according to claim 1, wherein the reference color coordinate comprises a color coordinate supplied from a selected display apparatus of the plurality of display apparatuses selected by the server.

10. The display system according to claim 9, wherein the server adjusts the image signal transmitted to another of the plurality of display apparatuses with the reference color coordinate when a deviation between the reference color coordinate and the color coordinate supplied by the another of the plurality of display apparatuses is outside of a range, and supplies the adjusted image signal to the another of the plurality of display apparatuses.

11. A display apparatus which displays an image signal supplied from a server through via a network, the display apparatus comprising:
a display unit which displays the image signal thereon;
a sensor device which senses a color coordinate of the image signal displayed on the display unit; and
a communication unit which communicates with the server through the network,
wherein the communication unit transmits the color coordinate to the server, and receives an adjusted image signal corresponding to the transmitted color coordinate.

12. The display apparatus according to claim 11, further comprising a storage unit which stores information therein,
wherein the communication unit supplies the color coordinate and the information to the server.

13. The display apparatus according to claim 12, wherein the information comprises an internet protocol (IP) address, and
the communication unit supplies the color coordinate and the IP address to the server.

14. The display apparatus according to claim 11, wherein the sensor device is provided in a front surface of the display unit and senses the image signal displayed on the display unit to generate the color coordinate sensed by the sensor device.

15. The display apparatus according to claim 11, wherein the communication unit communicates with the server through a wired local area network (LAN) or a wireless LAN.

16. A control method of a display apparatus which displays an image signal supplied by a server through a network, the control method comprising:
displaying the image signal;
sensing a color coordinate of the displayed image signal;
transmitting the color coordinate to the server; and
receiving an adjusted image signal corresponding to the transmitted color coordinate.

17. The control method according to claim 16, further comprising storing information,
wherein the transmitting the color coordinate to the server comprises supplying the color coordinate together with the information to the server.

18. The control method according to claim 17, wherein the information comprises an internet protocol (IP) address, and the transmitting the color coordinate to the server comprises supplying the color coordinate and the IP address to the server.
